(19) United States
(12) Patent Application Publication
(10) Pub. No.: US 2005/0045623 A1
(43) Pub. Date: Mar. 3, 2005

(54) Portable heated cushion

(75) Inventors: John Schenck, Seattle, WA (US); Mike Hammond, Tukwila, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: M & J Bottomline LLC, Seattle, WA (US)

(21) Appl. No.: 10/930,106

(22) Filed: Aug. 31, 2004

Related U.S. Application Data
(60) Provisional application No. 60/499,813, filed on Sep. 3, 2003.

(51) Int. Cl. H05B 3/34

(52) U.S. Cl. 219/528

(57) ABSTRACT

A portable heated cushion (100) is disclosed having a foam core (102) which may be substantially rectangular, a thermally reflective panel (104) positioned on the foam core, a flexible heating element (106) atop the thermally reflective panel, an elastic panel (108) covering the heating element, and an outer cover (110) covering the assembly. A power supply, such as a rechargeable battery pack (120), is disposed in the outer cover and electrically connected to the heating element. In one embodiment, the outer cover includes an aperture (124) positioned to provide access to leads (116, 118) on the rechargeable battery pack for charging. The portable heated cushion may further include a power supply for recharging the battery pack.

### CROSS-REFERENCE TO RELATED APPLICATION

This application claims the benefit of Provisional Application No. 60/499,813, filed Sep. 3, 2003, the benefit of which is hereby claimed under 35 U.S.C. § 119.

### FIELD OF THE INVENTION

The present invention relates to portable seat cushions and, in particular, to heated seat cushions.

### BACKGROUND OF THE INVENTION

Portable seat cushions that can be used in activities, frequently outdoor activities, are very popular. Such cushions are often used, for example, to make seating on bleachers at sporting events more comfortable. Portable seat cushions are also popular for use while engaging in outdoor activities, such as camping, hunting, boating, and the like. Because seat cushions are frequently used outdoors in cooler climates and during periods of relative inactivity by the user, it is desirable for seat cushions to be heated.

There are many challenges associated with providing a portable heated seat cushion. For example, the seat cushion, and particularly the electrical components of the system, must be flexible and yet rugged enough to withstand the rigors of use and misuse that are likely to be encountered at a sporting event and other outdoor activities. Also, the heating system must be efficient enough to provide heat to a user for an extended period of time using a portable power source.

Heated portable seat cushions have been contemplated before. For example, U.S. Pat. No. 5,034,594, to Beezhold et al. (“Beezhold”) discloses a portable, electrically heated seat cushion utilizing a conventional electrical resistance heating unit sandwiched between two foam cushions and powered by two “D” cells. The generally symmetrical apparatus of Beezhold, however, does not provide any means for directing the heat generated by the two batteries toward the user and, therefore, significant heat will be undesirably expended towards the bottom of the pad, away from the user. Also, a conventional heating unit, as disclosed by Beezhold, will generate heat over a relatively small area, requiring a relatively high peak temperature in order to transfer a given amount of heat. Higher peak temperatures require that the other elements, such as the foam pad, be selected to withstand such higher temperatures without damage.

Flexible substantially plastic heating elements have been used in certain applications where moderate heating is required—for example, in maintaining a comfortable temperature in a bathroom by providing heating elements in the floor. An example of such a heating element is disclosed in U.S. Pat. No. 5,961,869, which is hereby incorporated by reference. These flexible elements are typically made as a sheet of an electrically conductive plastic, such as a polyethylene and carbon black mixture, having embedded electrodes extending longitudinally adjacent one or more of the edges of the sheet. The electrodes are frequently made as a braided wire. The electrodes allow a potential to be applied across the sheet, the sheet producing a resistance thereto, causing the plastic sheet to heat. Typically, a plurality of slots extends along a length of the sheet, increasing the flexibility of the sheet and reducing the risk of cracking and the like due to thermally induced strains. These heating elements are typically installed on a layer of adhesive applied to the floor.

These heating elements provide several benefits. For example, they can operate at relative low voltages (typically 10-24 volts), are substantially self-regulating, and can achieve good heat transfer rates by producing a moderate temperature over a relatively large heat transfer area. Moreover, the use of these heating elements in floors provides a more even heat distribution, greater comfort, less temperature stratification, better control, increased ability to provide zoning, and the elimination of forced air that can circulate dust and germs.

### SUMMARY OF THE INVENTION

An efficient and portable heated seat cushion, suitable for use, for example, at sporting events, when engaging in outdoor activities, and the like, is disclosed. The heated cushion includes padded core, such as foam disposed in a flexible cover. Inside the cover, atop the padded core, is a heating system that includes a thermally reflective panel, a flexible heating element disposed above the reflective panel, and a cover panel over the heating element. A portable power supply is also provided, for example, a battery pack, that provides power to the heating element. The disclosed heating element has a relatively large surface area and the heat is preferentially directed towards the user, providing an efficient system capable of remaining warm for an extended period of time.

In an embodiment of the invention, the reflective panel includes an insulating layer, such as a bubble wrap material, and a foil layer. The heating element cover panel is an elastic polymeric sheet, such as neoprene, that is adhesively bonded to the heating element and the reflective panel.

In an embodiment of the invention, the portable power supply is a rechargeable battery pack and the heated cushion includes a separable power supply for charging the battery pack.

In an embodiment of the invention, the flexible outer cover is made of a fabric material that may be a natural material or a man-made material, and is sized to snugly accommodate the foam core, the thermally reflective panel, the flexible heating element, the cover panel, and the portable power supply. The outer surface of the flexible outer cover may be textured to inhibit slipping.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective, partially cut-away view of a portable heated cushion, according to the teachings of the present invention.

### DETAILED DESCRIPTION OF THE PREFERRED EMBODIMENT

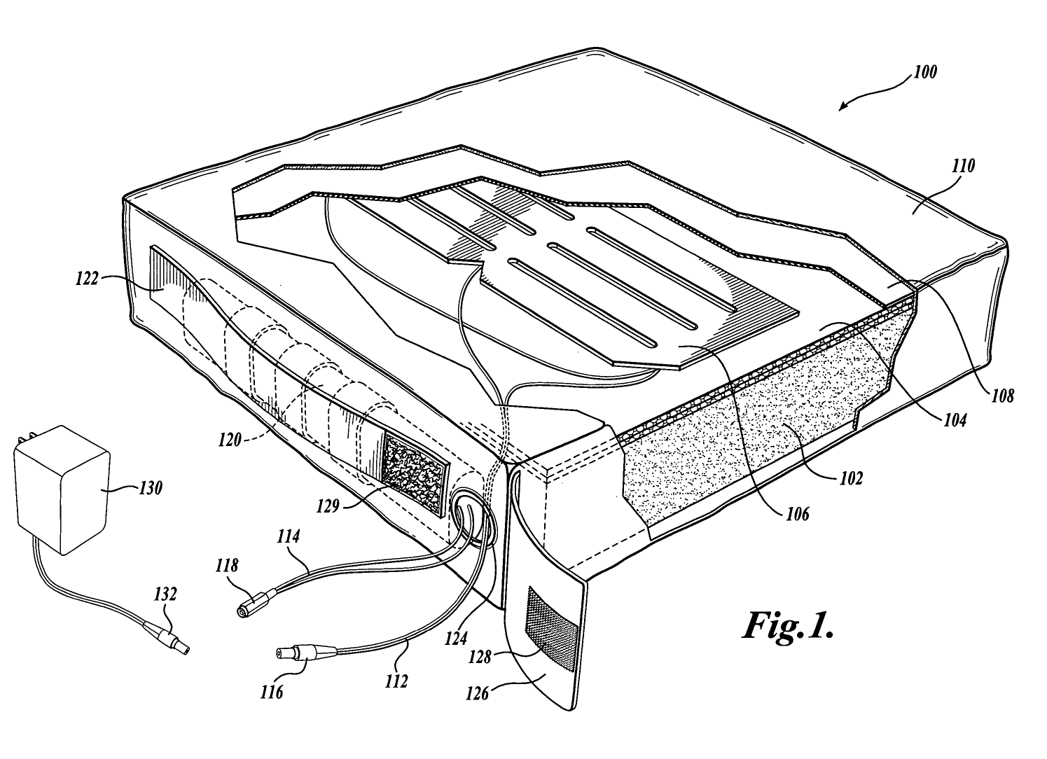

FIG. 1 illustrates a heated cushion 100 comprising a resilient foam core 102 that is generally in the form of a rectangular pad approximately 14 inches square by 1.5 inches thick. Other shapes and sizes for the cushions are also clearly within the scope of the present invention. A thermally reflective panel 104 is disposed over and substantially covers a top surface of the foam core 102. In the preferred embodiment, the thermally reflective panel 104 is made from an upwardly reflective flexible sheet, such as a foil sheet, sandwiched between a plastic transparent bubble wrap material. A plastic heating element 106, preferably made from a conductive polymer blend that becomes warm when an electric potential is applied across the material, is generally centrally disposed on top of the thermally reflective panel 104. The heating element 106 is a thin and flat flexible panel. An advantage of the plastic heating element 106 is that it is self-regulating, i.e., it will not exceed a particular design temperature. Therefore, no separate temperature modulation unit is required.

It will be appreciated that the bubble wrap material of the thermally reflective panel 104 provides a degree of thermal insulation between the foam core 102 and the heating element 106 and, therefore, cooperatively with the reflective foil sheet preferentially directs the thermal energy from the heating element 106 upwardly, toward the user. It is contemplated that additional insulating layers between the foam core 102 and the heating element 106 may also be provided.

A heating element cover 108 is disposed over the heating element 106. In the disclosed embodiment, the heating element cover 108 is an elastic sheet, such as neoprene, larger than the heating element 108, having an adhesive lower face. The heating element cover 108 therefore secures the heating element 106 in its generally central position to the thermally reflective panel 104. The heating element 106 is therefore protected and secured between the panel 104 and the heating element cover 108. An outer cover 110, which may be made from a plastic or natural fabric material, wraps about and provides an outer holder for the foam core 102, reflective panel 104, heating element 106, and heating element cover 108. In the disclosed embodiment, the cover 110 is of sewed construction and snugly accommodates the other components discussed above. The outer cover 110 preferably includes a convenient carry strap 122 along at least one edge. It is preferred that the outer cover be provided with a texture or other attribute to increase the friction force between the user and the cover 110 to reduce slipping and, therefore, increase the user's comfort.

A battery module 120 is disposed along one side of the foam core 102 and within the outer cover 110. The battery module 120 of the currently preferred embodiment of the present invention is a rechargeable 14.4 V, 2Ah Nickel-Cadmium battery pack, as is known in the art. It will be appreciated, however, that other battery modules or other portable power sources may alternatively be used, including, for example, fuel cell modules and the like.

The outer cover 110 includes an aperture 124 disposed near the battery module. The aperture 124 may be provided with a metal ring, such as a grommet or the like. A first lead assembly 114 extends from the battery module 120, electrically connecting to the positive and negative terminals of the battery module 120. The first lead assembly terminates at its distal end with a female connector 118.

The heating element includes a second lead assembly 112 that electrically connects to terminals on the heating element 106. The second lead assembly 112 terminates with a male connector 116 that is adapted to releasably mate physically and electrically with the female connector 118 such that the battery module 120 can provide a potential across the heating element 106. The female and male connectors 118, 116 are positioned on their respective lead assemblies 114, 112 such that the connectors 118, 116 can extend out the aperture 124.

A power supply 130 for charging the battery module 120 is also provided. The power supply 130 has a male connector 132 compatible with the battery module's 120 female connector 118, whereby the battery module 120 can be conveniently recharged. It will be appreciated now that the battery module 120 may be connected either to the power supply 130 for recharging by connecting the female connector 118 to the power supply male connector 132 (with the power supply connected to an AC power source) or to the heating element 106 by connecting the female connector 118 to the neutering element male connector 116.

In the disclosed embodiment, a protective flap 126 is provided with an attachment element 128 adapted to engage a second attachment element 129, such that the aperture 124 and connectors 116, 118 can be covered during use. The first and second attachment elements 128, 129 may be, for example, hook-and-loop type fasteners.

To use the portable heated pad 100, the battery module 120 is first charged by connecting the battery module 120 to the power supply 130 and connecting the power supply 130 to a power source, such as a wall outlet. After the battery module 120 is charged, the user simply disconnects the power supply 130 and transports the pad 100 to the desired location. Preferably, just prior to use (or just prior to when heat is desired), the user simply connects the charged battery module 130 to the heating element 106 and the pad 100 is ready for use.

Although the two-lead assembly for connecting the heating element 106 to the battery module 120 (or alternatively to connect the battery module 120 to the power supply 130) is currently preferred due to its inherent simplicity and reliability, it should be readily apparent to the artisan that other switching mechanisms may alternatively be utilized. For example, a switch may be utilized between the battery module 120 and the heating element 106 and/or a fixed recharging socket may be incorporated into the outer cover 110. Similarly, by straightforward extensions of the disclosed embodiment, the heating element 106 may be provided with more than one heat setting—for example, allowing the user to select between settings to either provide greater warmth or longer battery life. It is also contemplated that the heating element cover 108 and/or portions of the outer cover 110 may be provided with apertures or otherwise made porous to further enhance heat flow in the desired direction.

While the preferred embodiment of the invention has been illustrated and described, it will be appreciated that various changes can be made therein without departing from the spirit and scope of the invention.

1. A heated cushion comprising:
a foam core having an upper surface;
a thermally reflective panel disposed on the upper surface of the foam core;
a flexible heating element disposed on the thermally reflective panel;
a cover panel disposed over the flexible heating element;
a portable power supply electrically connected to the flexible heating element; and
a flexible cover enclosing the foam core, the thermally reflective panel, the flexible heating element, the cover panel, and the portable power supply.

2. The heated cushion of claim 1, wherein the cover panel comprises a sheet of neoprene.

3. The heated cushion of claim 1, wherein the cover panel is adhesively joined to the flexible heating element and the thermally reflective panel.

4. The heated cushion of claim 1, wherein the thermally reflective panel includes an upwardly reflective foil layer.

5. The heated cushion of claim 4, wherein the thermally reflective panel further comprises a thermally insulating layer.

6. The heated cushion of claim 5, wherein the thermally insulating layer comprises a bubble wrap material.

7. The heated cushion of claim 1, wherein the portable power supply is a rechargeable battery pack.

8. The heated cushion of claim 7, further comprising a removable power supply that recharges the rechargeable battery pack.

9. The heated cushion of claim 1, wherein the flexible cover comprises a fabric material sized to snuggly accommodate the foam core, the thermally reflective panel, the flexible heating element, the cover panel, and the portable power supply.

10. The heated cushion of claim 1, wherein at least a portion of an outer surface of the flexible cover is textured to inhibit slipping.

11. The heated cushion of claim 10, wherein the flexible cover further comprises an aperture positioned to provide access the portable power supply and a closable protective flap positioned to cover the aperture.

12. The heated cushion of claim 1, wherein the flexible heating element comprises a conductive plastic panel.

13. The heated cushion of claim 1, wherein the heating element is positioned to preferentially direct heat upwardly and there is no insulation disposed above the heating element.

14. A heated cushion comprising:
an insulating core having an upper surface;
a flexible heating element formed of a conductive plastic panel disposed above the upper surface of the insulating core;
a portable power supply electrically connected to the flexible heating element; and
a flexible cover enclosing the insulating core, the flexible heating element and the portable power supply.

15. A heated cushion comprising:
a foam core having an upper surface;
a thermally reflective panel disposed on the upper surface of the foam core;
a flexible heating element disposed on the thermally reflective panel;
a portable power supply electrically connected to the flexible heating element; and
a flexible cover enclosing the foam core, the thermally reflective panel, the flexible heating element, the cover panel and the portable power supply.
